(19) United States
(12) Patent Application Publication
(10) Pub. No.: US 2018/0018118 A1
(43) Pub. Date: Jan. 18, 2018

(54) POWER MANAGEMENT IN SCENARIOS THAT HANDLE ASYNCHRONOUS STIMULUS

(71) Applicant: QUALCOMM Incorporated, San Diego, CA (US)

(72) Inventors: Sharath Raghava, Campbell, CA (US); Jhy-ping Shaw, San Jose, CA (US); Vinodh Cuppu, San Jose, CA (US); Paul Min, Cupertino, CA (US)

(21) Appl. No.: 15/211,607

(22) Filed: Jul. 15, 2016

(51) Int. Cl. G06F 3/06; G06F 1/32; G06F 1/12

(52) U.S. Cl. CPC G06F 3/0625; G06F 3/0673; G06F 12/1009; G06F 1/12; G06F 3/0659; G06F 1/324; G06F 2212/1028

(57) ABSTRACT

In one embodiment, a method for power management includes receiving one or more state signals, each of the one or more state signals indicating whether a respective sub-block of a memory controller is idle or active, and determining whether to place the memory controller in an idle state or an active state based on the one or more state signals. The method also includes eating pulses of an input clock signal to produce a reduced-frequency clock signal if a determination is made to place the memory controller in the idle state, wherein the reduced-frequency clock signal is output to the memory controller. The method further includes passing the input clock signal to the memory controller if a determination is made to place the memory controller in the active state.

### BACKGROUND

### Field

Aspects of the present disclosure relate generally to power management, and more particularly, to power management in mobile devices.

### Background

Reducing power consumption in a mobile device is important in order to extend the battery life of the mobile device. A significant contributor to power consumption of a chip (die) in a mobile device is dynamic power, which is due to switching of transistors on the chip. In this regard, various power reduction schemes have been developed to reduce dynamic power consumption on a chip. For example, one scheme involves gating a clock signal to a block (circuit) on the chip when the block is in an idle state. Gating the clock signal to the block stops transistors in the block from switching, thereby reducing the dynamic power of the block.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A first aspect relates to a power management device. The power management device includes a power controller configured to receive one or more state signals, each of the one or more state signals indicating whether a respective sub-block of a memory controller is idle or active. The power management device also includes a clock eater configured to operate in a first mode and a second mode, wherein, in the first mode, the clock eater is configured eat pulses of an input clock signal to produce a reduced-frequency clock signal and to output the reduced-frequency clock signal to the memory controller, and, in the second mode, the clock eater is configured to pass the input clock signal to the memory controller. The power controller is further configured to make a determination to operate the clock eater in the first mode or the second mode based on the one or more state signals, and to command the clock eater to operate in the first mode or the second mode based on the determination.

A second aspect relates to a method for power management. The method includes receiving one or more state signals, each of the one or more state signals indicating whether a respective sub-block of a memory controller is idle or active, and determining whether to place the memory controller in an idle state or an active state based on the one or more state signals. The method also includes eating pulses of an input clock signal to produce a reduced-frequency clock signal if a determination is made to place the memory controller in the idle state, wherein the reduced-frequency clock signal is output to the memory controller. The method further includes passing the input clock signal to the memory controller if a determination is made to place the memory controller in the active state.

A third aspect relates to an apparatus for power management. The apparatus includes means for receiving one or more state signals, each of the one or more state signals indicating whether a respective sub-block of a memory controller is idle or active, and means for determining whether to place the memory controller in an idle state or an active state based on the one or more state signals. The apparatus also includes means for eating pulses of an input clock signal to produce a reduced-frequency clock signal if a determination is made to place the memory controller in the idle state, and means for outputting the reduced-frequency clock signal to the memory controller. The apparatus further includes means for passing the input clock signal to the memory controller if a determination is made to place the memory controller in the active state.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a system on a chip (SoC) including multiple processers and a memory controller according to certain aspects of the present disclosure.

FIG. 2 shows an example of a memory controller according to certain aspects of the present disclosure.

FIG. 3 shows an example of a power management device for a memory controller according to certain aspects of the present disclosure.

FIG. 4 shows an example of a power management device including a clock eater according to certain aspects of the present disclosure.

FIG. 5 shows an example of clock eating according to certain aspects of the present disclosure.

FIG. 6 shows an exemplary implementation of the clock eater according to certain aspects of the present disclosure.

FIG. 7 shows an exemplary implementation of a gating circuit according to certain aspects of the present disclosure.

FIG. 8A shows an exemplary implementation of a power controller according to certain aspects of the present disclosure.

FIG. 8B shows another exemplary implementation of a power controller according to certain aspects of the present disclosure.

FIG. 9 shows an exemplary implementation of a synchronizer according to certain aspects of the present disclosure.

FIG. 10 shows an example in which state signals are aggregated using an AND gate according to certain aspects of the present disclosure.

FIG. 11 shows an example of a power controller including hysteresis circuits according to certain aspects of the present disclosure.

FIG. 12 shows an exemplary implementation of a hysteresis circuit according to certain aspects of the present disclosure.

FIG. 13 shows an example in which a signal path of a hysteresis circuit passes through a synchronizer according to certain aspects of the present disclosure.

FIG. 14 shows an example of a clock gating architecture according to certain aspects of the present disclosure.

FIG. 15 is a flowchart illustrating a method for power management according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

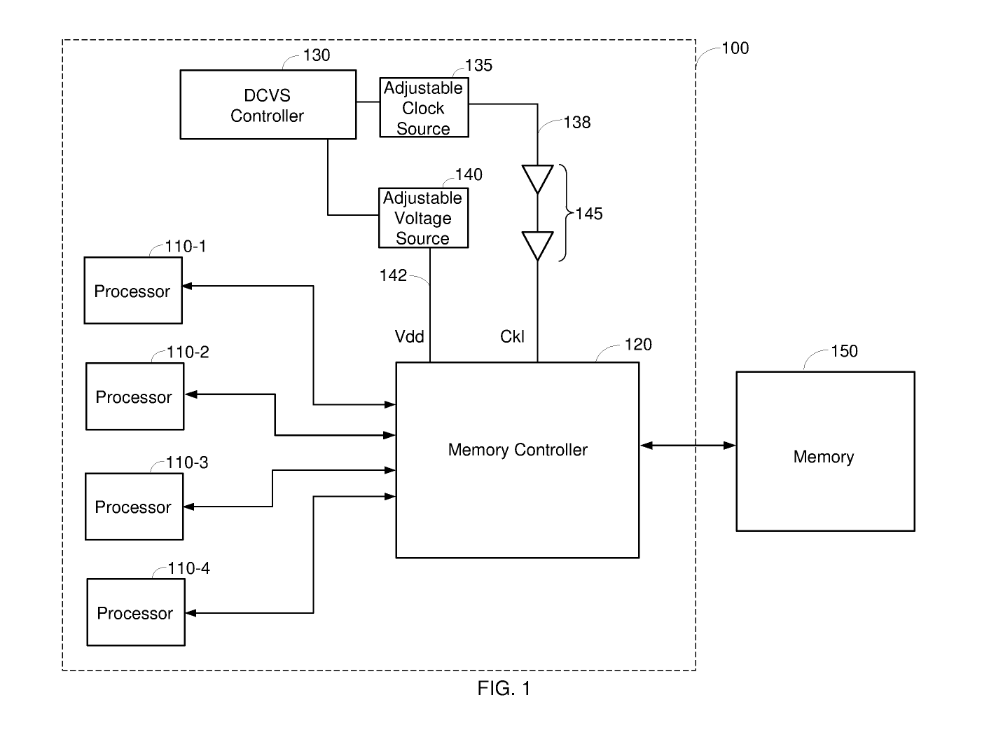

FIG. 1 shows an example of a SoC 100 including multiple processors 110-1 to 110-4, and a memory controller 120. The multiple processors 110-1 to 110-4 may include a graphics processing unit (GPU), a central processing unit (CPU), a digital signal processor (DSP), a video encoder/decoder, etc. The multiple processors 110-1 to 110-4 access a shared memory 150 (also referred to as main memory) via the memory controller 120. The shared memory 150 may be external to the SoC 100 (i.e., located on another chip or die), and may include a double data rate synchronous dynamic random address memory (DDR SDRAM) or another type of memory.

In the example shown in FIG. 1, the memory controller 120 is integrated on the SoC 100. In this example, the memory controller 120 may also be referred to as an integrated memory controller (IMC), a bus-integrated memory controller (BIMC), or another terminology. The memory controller 120 is responsible for buffering and serving memory requests from the processors 110-1 to 110-4, as discussed further below. The memory controller 120 may communicate with the memory 150 via multiple lines (e.g., traces), as discussed further below.

To write data to the memory 150, a processor (e.g., GPU or CPU) may send a write request to the memory controller 120. The write request may include the data and a logical address for the data. To service the write request, the memory controller 120 may map the logical address to a physical address in the memory 150, and send corresponding command/address/data signals to the memory 150 to write the data to the physical address in the memory 150. The memory controller 120 may also send a signal to the processor indicating that the write operation has been completed.

To read data from the memory 150, a processor (e.g., GPU or CPU) may send a read request to the memory controller 120. The read request may include a logical address for the data to be read from the memory 150. To service the read request, the memory controller 120 may map the logical address to a physical address in the memory, and send corresponding command/address signals to the memory 150 to read the data from the physical address in the memory 150. Upon receiving the data from the memory 150, the memory controller 120 sends the data to the processor.

The processors 110-1 to 110-4 may share the memory 150 on a time-shared basis. For example, the memory controller 120 may receive read/write requests from the processors 110-1 to 110-4, place the read/write requests in one or more buffers (not shown), and process the read/write requests in the one or more buffers one at a time. In this regard, the memory controller 120 may schedule and perform read/write operations to service the read/write requests.

The memory controller 120 may support different operating frequencies. In this regard, the SoC 100 may include a dynamic clock voltage scaling (DCVS) controller 130, an adjustable clock source 135, and an adjustable voltage source 140. The adjustable clock source 135 is configured to provide a clock signal Clk (e.g., DDR clock signal) having an adjustable frequency to the memory controller 120 for timing operations of the memory controller 120 (e.g., timing data transfers to and from the memory 150). The clock signal clk may be provided to the memory controller 120 via a clock path 138, which may include one or more buffers 145 (e.g., inverters). In this example, the DCVS controller 130 may adjust the operating frequency of the memory controller 120 by adjusting the frequency of the clock signal Clk accordingly, as discussed further below.

The adjustable voltage source 140 is configured to provide a supply voltage Vdd having an adjustable voltage level to the memory controller 120 via a power distribution network 142 for powering the memory controller 120. In this example, the DCVS controller 130 may adjust the voltage level of the supply voltage Vdd over a voltage range by adjusting the voltage level of the adjustable voltage source 140 accordingly, as discussed further below.

In certain aspects, the adjustable clock source 135 may support a set of different frequencies. In these aspects, the DCVS controller 130 may set the frequency of the clock signal clk to any one of the frequencies in the set. In one example, each frequency in the set may be paired with a corresponding supply voltage level that enables transistors in the memory controller 120 to switch fast enough to operate reliably at the frequency. For instance, a higher frequency may be paired with a higher supply voltage level than a lower frequency since a higher supply voltage level may be required to operate at the higher frequency. Thus, when the DCVS controller 130 sets the frequency of the clock signal clk at a particular frequency, the DCVS controller 130 may also set the supply voltage at the corresponding voltage level (i.e., the supply voltage level paired with the frequency). It is to be appreciated that two or more frequencies may be paired with the same supply voltage.

The DCVS controller 130 may adjust the frequency of the clock signal Clk based on the amount of data being transferred between the processors 110-1 to 110-4 and the memory 150, performance requirements of the system, etc., as discussed further below.

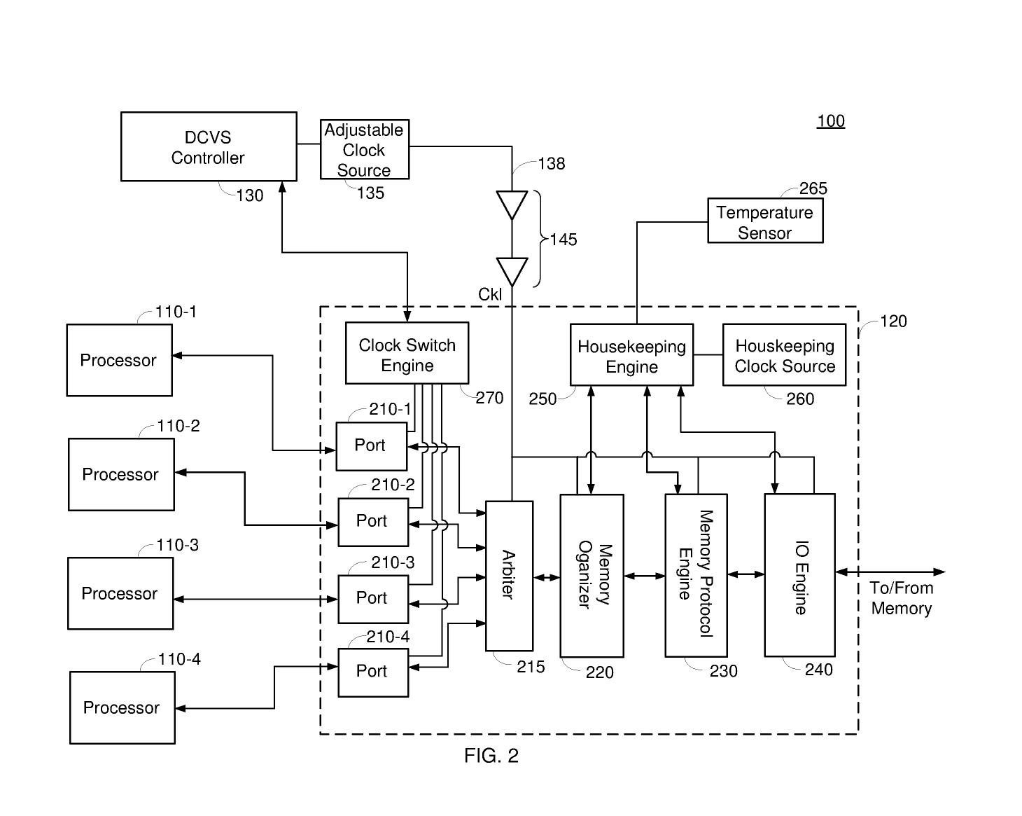

FIG. 2 shows an example of the memory controller 120 according to certain aspects of the present disclosure. For ease of illustration, the adjustable voltage source 140 and the memory 150 are not shown in FIG. 2.

In this example, the memory controller 120 is a multi-port memory controller 120 including multiple ports 210-1 to 210-4, in which each port 210-1 to 210-4 is coupled to a respective one of the processors 110-1 to 110-4. The memory controller 120 also includes an arbiter 215, a memory organizer 220, a memory protocol engine 230, an input-output (IO) engine 240, a housekeeping engine 250, a housekeeping clock source 260, and a clock switch engine 270.

Each port 210-1 to 210-4 is configured to receive read/write requests from the respective processor 110-1 to 110-4. This allows the memory controller 120 to receive read/write requests from the processors 110-1 to 110-4 in parallel. Each port 210-1 to 210-4 may include a buffer (e.g., first-in-first-out (FIFO) buffer) for temporarily storing read/write requests from the respective processor 110-1 to 110-4. Each port 210-1 to 210-4 may also be configured to receive data read from the memory 150 in response to a read request from the respective processor, and send the received data to the respective processor.

The arbiter 215 may be configured to retrieve read/write requests from the ports 210-1 to 210-4, and forward the retrieved the read/write requests to the memory organizer 220 for servicing. For example, the arbiter 215 may retrieve the read/write requests from the ports 210-1 to 210-4 based on the order in which the read/write requests are received by the ports (e.g., retrieve the oldest read/write request first). In another example, the arbiter 215 may prioritize read/write requests from one of the processors over read/write requests from the other processors. In this example, the arbiter 215 may retrieve pending read/write requests from the port corresponding to the one processor before retrieving read/write requests from the other ports. It is to be appreciated that the arbiter 215 is not limited to the above examples, and may retrieve read/write requests from the ports 210-1 to 210-4 based on other arbitration policies.

As discussed above, the arbiter 215 forwards read/write requests to the memory organizer 220. To service a read/write request, the memory organizer 220 may send read/write instructions to the memory protocol engine 230 to perform read/write operations for the read/write request. For example, for a write request, the memory organizer 220 may send a write command, the data to be written, and a logical address for the data to be written to the memory protocol engine 230. In response, the memory protocol engine 230 may map the logical address to a physical address in the memory, and generate command/address/data signals to write the data to the memory 150 according to the protocol (standard) used by the memory 150. For example, if the memory 150 is a DDR SDRAM, the memory protocol engine 230 may generate command/address/data signals according to the DDR SDRAM protocol (standard) used by the memory 150. The memory protocol engine 230 may send the generated command/address/data signals to the IO engine 240 for transmission to the memory 150, as discussed further below.

For a read request, the memory organizer 220 may send a read command, and a logical address for the data to be read from the memory 150 to the memory protocol engine 230. In response, the memory protocol engine 230 may map the logical address to a physical address in the memory, and generate command/address signals to read the data from the memory 150 according to the protocol (standard) used by the memory 150. The memory protocol engine 230 may send the generated command/address signals to the IO engine 240 for transmission to the memory 150, as discussed further below.

The IO engine 240 provides a physical interface between the memory controller 120 and the memory 150, and may also be referred to as a physical (PHY) block. In this regard, the IO engine 240 may include multiple output drivers (not shown) for transmitting command/address/data signals received from the memory protocol engine 230 to the memory 240 via multiple lines. The IO engine 240 may also include multiple receivers for receiving command/address/data signals from the memory 150 via the multiple lines, and sending the received command/address/data signals to the memory protocol engine 230. The IO engine may also include timing circuits (not shown) for synchronizing (aligning) incoming and/or outing going signals (e.g., with a data strobe signal), as discussed further below. The timing circuits may include adjustable delay elements and/or other types of timing circuits.

When the IO engine 240 receives data signals from the memory 150 including data read from the memory 150, the IO engine 240 may send the received data signals to the memory protocol engine 230. The protocol engine 230 may recover the data from the data signals and send the data to the memory organizer 220. The memory organizer 220 may then send the data to the port corresponding to the processor that requested the data (i.e., the processor that sent the read request requesting the data) via the arbiter 215. The corresponding port may then transmit the data to the requesting processor.

The housekeeping engine 250 may initiate housekeeping operations such as refresh operations, ZQ calibrations, and time training operations, as discussed further below.

The housekeeping engine 250 may periodically command the memory organizer 220, the memory protocol engine 230 and/or IO engine 240 to perform refresh operations. The refresh operations may include reading data from the memory 150, and writing the read data back to the memory 150 to refresh the data in the memory 150. For example, the data in the memory 150 may be stored as electrical charges on capacitors that leak over time. In this example, the data may need to be periodically refreshed to prevent the data from being lost.

The housekeeping engine 250 may also periodically command the memory organizer 220, the memory protocol engine 230 and/or IO engine 240 to perform ZQ calibration operations. The ZQ calibration operations may include calibrating on-die termination (ODT) impedances and/or output driver impedances of the IO engine 240 to maintain signal integrity between the memory controller 120 and the memory 150.

The housekeeping engine 250 may also periodically command the memory organizer 220, the memory protocol engine 230 and/or IO engine 240 to perform time training operations. The time training operations may include sending training sequences between the memory controller 120 and the memory 150 to measure skew between outgoing and/or incoming signals, and making timing adjustments to the signals based on the measured skew to compensate for the skew.

For example, the memory controller 120 may transmit data to the memory 150 using multiple data signals transmitted to the memory 150 in parallel over multiple data lines (e.g., DQ lines). The memory controller 120 may also transmit a clock signal (e.g., data strobe) with the data signals to allow the memory 150 to synchronize its receiver with the data signals. Similarly, the memory 150 may transmit data to the memory controller 120 using multiple data signals transmitted to the memory controller 120 in parallel over the multiple data lines (e.g., DQ lines). The memory 150 may also transmit a clock signal (e.g. data strobe) with the data signals to allow the IO engine 240 to synchronize with the incoming data signals. In this example, the edges of the data signals and clock signal may be skewed (misaligned) with respect to one another due to, for example, mismatches in the lengths of the data lines. To compensate for the skew, the memory controller 120 may measure the skew, and make timing adjustments to the signals based on the measured skew to compensate for the skew. To do this, the IO engine 240 may include an adjustable delay element (not shown) for each data line. In this example, the IO engine 240 may make the timing adjustments to the signals by adjusting the delays of the delay elements based on the measured skew.

In certain aspects, the housekeeping clock source 260 provides the housekeeping engine 250 with a housekeeping clock signal to time housekeeping operations. The housekeeping clock signal may be slower than the clock signal Clk provided by the adjustable clock source 135. For example, the housekeeping clock signal may have a frequency in the KHz range (e.g., 32 KHz) while the clock signal Clk may have a frequency in the MHz and/or GHz range.

In one example, the housekeeping engine 250 may include one or more counters (not shown), in which each counter corresponds to a respective one of the housekeeping operations discussed above. In this example, the housekeeping engine 250 may drive each counter with the housekeeping clock signal, and compare the count value of each counter with a respective predetermined count value. When the count value of a counter reaches the respective predetermined count value, the housekeeping engine 250 may initiate the respective housekeeping operation (e.g., refresh operation, ZQ calibration or time training operation), and reset the counter. Thus, for a housekeeping operation that is timed using a counter, the time period between initiations of the housekeeping operation is controlled by the respective predetermined count value.

In another example, the housekeeping engine 250 may monitor temperature on the chip by receiving temperature readings from an on-chip temperature sensor 265. In this example, the housekeeping engine 250 may initiate a housekeeping operation when the monitored temperature changes by a certain amount. For instance, the housekeeping engine 250 may initiate a ZQ calibration when the monitored temperature changes by a certain amount to compensate the ODT impedances and/or output driver impedances of the IO engine 240 for changes in temperature.

The clock switch engine 270 is configured to send a request to the DCVS controller 130 to change the frequency of the clock signal Clk. For example, the clock switch engine 270 may monitor read/write requests at the ports 210-1 to 210-4, estimate the bandwidth (data traffic) between the processors 110-1 to 110-4 and the memory controller 120 based on the monitored read/write requests, and determine a frequency of the clock signal Clk based on the estimated bandwidth. For example, the clock switch engine 270 may determine a lower frequency for a smaller bandwidth to reduce power consumption, and a higher frequency for a larger bandwidth in order to meet one or more performance requirements. The clock switch engine 270 may then send a request to the DCVS controller 130 to change the frequency of the clock signal Clk to the determined frequency. The DCVS controller 130 may then change the frequency of the clock signal Clk to the frequency in the request. The clock switch engine 270 may also determine the bandwidth (data traffic) between the processors 110-1 to 110-4 and the memory controller 120 by monitoring read/write requests in cache memories of the processors.

In certain aspects, the clock signal Clk may be distributed to the arbiter 215, the memory organizer 220, the memory protocol engine 230, and the IO engine 240 (as shown in FIG. 2) to time operations of the arbiter 215, the memory organizer 220, the memory protocol engine 230, and the IO engine 240. In this regard, the data transfer rate between the IO engine 240 and the memory 150 may be equal to or proportional to the frequency of the clock signal Clk depending, for example, on the number of data lines between the IO engine 240 and the memory 150. Although not explicitly shown in FIG. 2, the supply voltage Vdd may be distributed to the ports 210-1 to 210-4, the arbiter 215, the memory organizer 220, the memory protocol engine 230, the IO engine 240, the housekeeping engine 250, the housekeeping clock source 260 and/or the clock switch engine 270 to power these sub-blocks.

In certain aspects, communication between the processors 110-1 to 110-4 and the ports 210-1 to 210-4 may be clocked using an interface clock signal, which may be different from the clock signal Clk. For example, the processors 110-1 to 110-4 and the ports 210-1 to 210-4 may communicate over an advanced extensible interface (AXI) bus. In this example, communication between the processors 110-1 to 110-4 and the ports 210-1 to 210-4 may be clocked using an AXI clock signal.

In one example, each port 210-1 to 210-4 may retime read/write requests received from the respective processor 110-1 to 110-4 from the clock domain of the interface clock signal to the clock domain of the clock signal Clk before forwarding the read/write requests to the arbiter 215. Similarly, each port 210-1 to 210-4 may retime data received from the arbiter 215 from the clock domain of the clock signal Clk to the clock domain of the interface clock signal before forwarding the data to the respective processor. To do this, each port may receive the interface clock signal and the clock signal Clk. Thus, in this example, the clock signal Clk may also be distributed to the ports 210-1 to 210-4. It is to be appreciated that the present disclosure is not limited to this example and that retiming between the two clock domains may instead be performed at the arbiter 215, the memory organizer 220, or the protocol engine 230.

To conserve power, the memory controller 120 may be placed in an idle state when one or more sub-blocks of the memory controller 120 are idle. The sub-blocks may include the ports 210-1 to 210-4, the arbiter 215, the memory organizer 220, the memory protocol 230, the IO engine 240, the clock switch engine 270, and the housekeeping engine 250. The memory controller 120 may be placed in the idle state by gating and/or slowing down the clock signal Clk to the memory controller 120, as discussed further below. Gating and/or slowing down the clock signal Clk reduces power consumption of the SoC 100 by reducing the dynamic power of the memory controller 120.

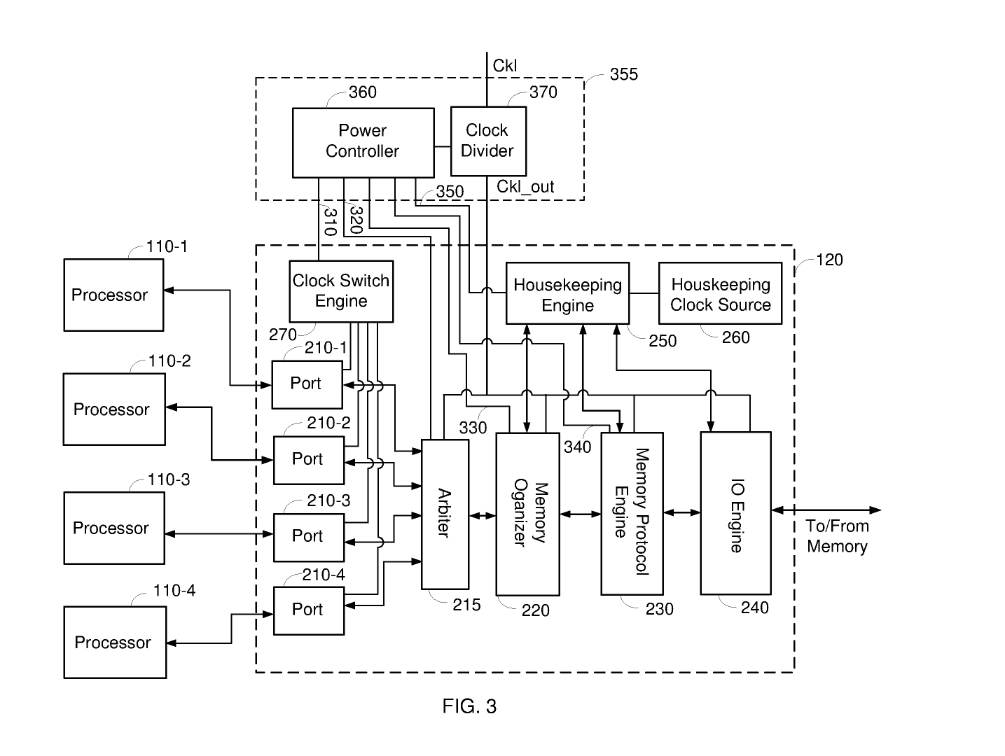

FIG. 3 illustrates a power management device 355 according to one approach. In this example, the power management device 355 includes a power controller 360, and a clock divider 370. For ease of illustration, the DCVS controller 130, and the adjustable clock source 135 are not shown in FIG. 3.

The clock divider 370 is configured to reduce the frequency of the clock signal Clk when the memory controller 120 is in the idle state. The clock divider 370 reduces the frequency of the clock signal Clk by dividing the frequency of the clock signal Clk by a divider value, as discussed further below. When the memory controller 120 is in an active state (e.g., servicing a write/read request), the clock divider 370 allows the clock signal Clk to pass to the memory controller 120 at full clock frequency (i.e., the frequency of the input clock signal Clk).

In operation, the power controller 360 monitors the states of sub-blocks of the memory controller 120, and makes a determination whether to place the memory controller 120 in the idle state based on the monitored states. For example, the power controller 360 may make a determination to place the memory controller 120 in the idle state when a subset of the monitored sub-blocks is idle, or all of the monitored sub-blocks are idle.

When the power controller 360 makes a determination to place the memory controller 120 in the idle state, the power controller 360 sends a command to the clock divider 370 to divide the frequency of the clock signal Clk by a divider value to generate a reduced-frequency clock signal at the output of the clock divider 370 (denoted “Clk_out” in FIG. 3). For example, the clock divider 370 may divide the frequency of the clock signal Clk by a divider value of 4, 8, 16, or another divider value. The reduced-frequency clock signal Clk_out is input to the memory controller 120. The reduced clock frequency reduces dynamic power of the memory controller 120 in the idle state by operating sub-blocks of the memory controller 120 at a reduced speed. This allows the sub-blocks to receive a read/write request when the memory controller 120 is in the idle state while reducing power consumption, as discussed further below.

When one or more of the sub-blocks becomes active (e.g., in response to an incoming read/write request), the power controller 360 may place the memory controller 120 back in the active state. For example, the arbiter 215 may transition from the idle state to the active state when at least one of the ports receives a read/write request from the respective processor. To place the memory controller 120 in the active state, the power controller 360 sends a command to the clock divider 370 to allow the clock signal Clk to pass to the memory controller 120 without frequency division. In other words, the clock signal Clk_out at the output of the clock divider 370 is at full frequency (i.e., the frequency of the input clock signal Clk).

As discussed above, the power controller 360 monitors the states of one or more sub-blocks of the memory controller 120. In this regard, each of the one or more sub-blocks may output a state signal to the power controller 360 indicating a state of the respective sub-block. For instance, the logic state (e.g., one or zero) of each state signal may indicate whether the respective sub-block is idle or active.

In this regard, the arbiter 215 may output a state signal 320 to the memory controller 360 indicating the state of the arbiter 215. In this example, the state signal 320 may indicate that the arbiter is active when there is at least one read/write request in the buffer (e.g., FIFO) of at least one of the ports, and may indicate that the arbiter 215 is idle when there are no read/write requests in the buffer (e.g., FIFO) of any of the ports.

The memory organizer 220 may output a state signal 330 to the memory controller 360 indicating a state of the memory organizer 220. In this example, the state signal 330 may indicate that the memory organizer 220 is active when the memory organizer 220 is servicing one or more read/write requests, and may indicate that the memory controller 220 is idle when the memory organizer 220 is not servicing a read/write request.

The memory protocol engine 230 may output a state signal 340 to the memory controller 360 indicating a state of the memory protocol engine 230. In this example, the state signal 340 may indicate that the memory protocol engine 230 is active when the memory protocol engine 230 is performing one or more read/write operations (e.g., to service one or more read/write operations), and may indicate that the memory protocol engine 230 is idle when the memory protocol engine is not performing a read/write operation.

The housekeeping engine 250 may output a state signal 350 to the memory controller 360 indicating a state of the housekeeping engine 250. In this example, the state signal 350 may indicate that the housekeeping engine is active when one or more housekeeping operations (e.g., refresh operation, ZQ calibration and/or time training operations) are being performed, and may indicate that the housekeeping engine 250 is idle when no housekeeping operations are being performed.

The clock switch engine 270 may output a state signal 310 to the memory controller 360 indicating a state of the clock switch engine 270. In this example, the state signal 310 may indicate that the clock switch engine 270 is active when the clock switch engine 270 is monitoring data traffic, and indicate that the clock switch engine 270 is idle when the clock switch engine 270 is not monitoring data traffic.

The power controller 360 may receive the state signals 310, 320, 330, 340 and 350 from the clock switch engine 270, the arbiter 215, the memory organizer 220, the memory protocol engine 230 and/or the housekeeping engine 250. In this example, the power controller 360 may make a determination to place the memory controller 120 in the idle state when all of the state signals indicate that the respective sub-blocks are idle. The power controller 360 may make a determination to place the memory controller 120 in the active state when at least one of the state signals indicate that the respective sub-block is active.

As discussed above, the power management device 355 in FIG. 3 uses the clock divider 370 to reduce the frequency of the clock signal Clk when the memory controller 120 is in the idle state. A disadvantage of using the clock divider 370 is that there is a synchronization latency associated with transitioning the output clock signal Clk_out of the clock divider 370 from the reduced clock frequency (divided clock frequency) to the full clock frequency when the memory controller 120 wakes up (i.e., transitions from the idle state to the active state). The synchronization latency increases the amount of time it takes for the memory controller 120 to wakeup (i.e., transition from the idle state to the active state) to service a write/read request from one of the processors 110-1 to 110-4.

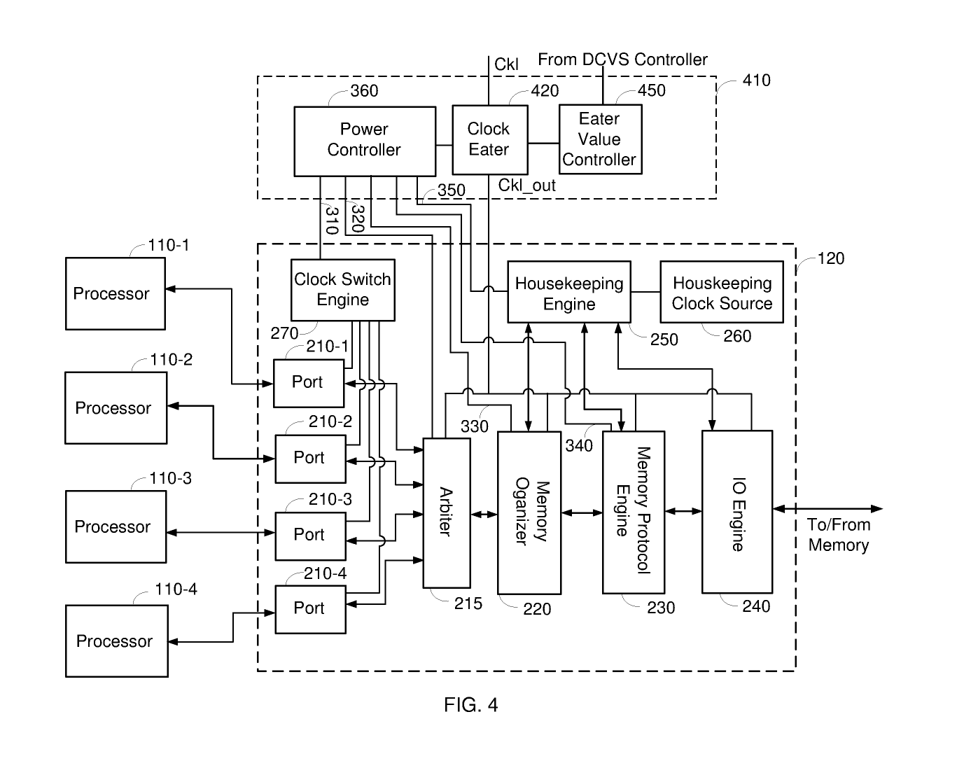

Embodiments of the present disclosure address the synchronization latency associated with the clock divider 370 by replacing the clock divider 370 with a clock eater (also referred to as a clock swallower). In this regard, FIG. 4 shows an exemplary power management device 410 according to certain aspects of the present disclosure. The power management device 410 includes the power controller 360, and a clock eater 420 (also referred to as a clock swallower) in place of the clock divider 370.

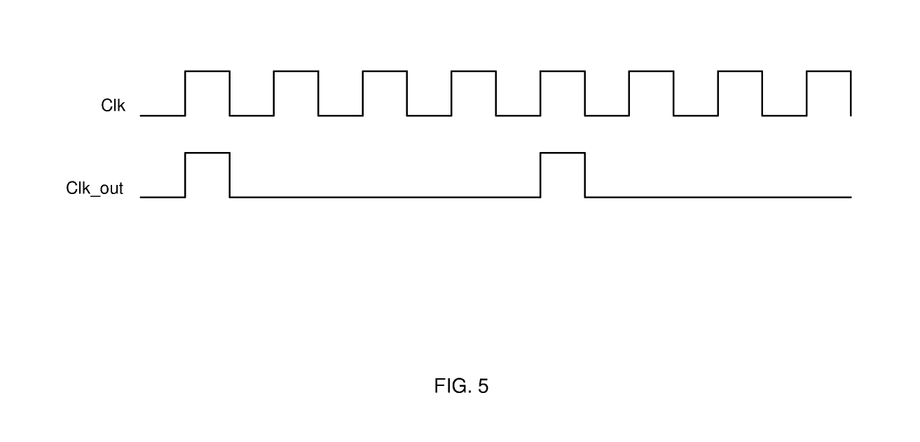

The clock eater 420 is configured to operate in a first mode and a second mode under the control of the power controller 360. In the first mode, the clock eater 420 is configured to reduce the frequency of the clock signal Clk by allowing every Nth clock pulse of the clock signal Clk to pass to the memory controller 120, and eating (swallowing) the remaining clock pulses. An example of this is shown in FIG. 5. In this example, the clock eater 420 reduces the frequency of the clock signal Clk by 75% at the output of the clock eater 420 (denoted “Clk_out”) by allowing every fourth clock pulse to pass, and eating (swallowing) the remaining clock pulses. It is to be appreciated that N is not limited to the value of four shown in FIG. 5, and may have other values. N may be referred as a clock eater value.

Thus, the clock eater value N specifies the percentage of clock pulses of the clock signal Clk that are eaten. For example, the clock eater value of four in the above example corresponds to 75% of the clock pulses being eaten. In the above example, the clock eater value indicates that one out of every N clock pulses is passed. However, it is to be appreciated that the clock eater value is not limited to this example. For example, the clock eater value may indicate that one out of every N clock pulses is eaten and the remaining clock pulses are passed. In either case, the clock eater value specifies the percentage of clock pulses of the clock signal Clk that are eaten.

In the second mode, the clock eater 420 is configured to pass the clock signal Clk to the memory controller 120 without clock eating (clock swallowing). In this case, the clock signal Clk_out at the output of the clock eater 420 is at full frequency (i.e., the frequency of the input clock signal Clk).

As discussed above, the power controller 360 may monitor the states of sub-blocks of the memory controller 120, and make a determination whether to place the memory controller 120 in the idle state based on the monitored states. For example, the power controller 360 may receive state signals 310, 320, 330, 340 and 350 from the clock switch engine 270, the arbiter 215, the memory organizer 220, the memory protocol engine 230 and/or the housekeeping engine 250. In this example, the power controller 360 may make a determination to place the memory controller 120 in the idle state when all of the state signals indicate that the respective sub-blocks are idle. In this case, the power controller 360 commands the clock eater to operate in the first mode (i.e., reduce the frequency of the clock signal Clk by eating (swallowing) clock pulses of the clock signal Clk). The power controller 360 may make a determination to place the memory controller 120 in the active state when at least one of the state signals indicates that the respective sub-block is active. In this case, the power controller 360 commands the clock eater 420 to operate in the second mode (i.e., pass the clock signal Clk to the memory controller 120 without clock eating (swallowing)).

An advantage of the clock eater 420 over the clock divider 370 is that the clock eater 420 is able to change the frequency of the clock signal Clk_out output to the memory controller 120 much faster than the clock divider 370. This reduces the amount of time it takes for the memory controller 120 to wakeup (i.e., transition from the idle state to the active state) to service a write/read request.

The power management device 410 may also include an eater value controller 450 configured to set the clock eater value of the clock eater 420. In one embodiment, the eater value controller 450 may program the clock eater value based on the frequency of the clock signal Clk input to the clock eater 420. For example, the eater value controller 450 may include a register that stores a look-up table mapping each available frequency of the clock signal Clk to a clock eater value. In this example, the eater value controller 450 may receive a signal from the DCVS controller 130 indicating the frequency of the clock signal Clk. The eater value controller 450 may then look up the corresponding clock eater value in the table (i.e., the clock eater value in the table that is mapped to the frequency of the clock signal Clk), and program the corresponding clock eater value in the clock eater 420.

In certain aspects, the table may include a higher clock eater value for a higher frequency of the clock signal Clk than a lower frequency of the clock signal Clk. This is because the frequency of the clock signal Clk may be reduced by a greater amount when the frequency of the clock signal Clk is higher. Thus, clock eating (swallowing) may be done more aggressively at a higher frequency of the clock signal Clk than at a lower frequency of the clock signal Clk.

In certain aspects, a frequency range supported by the DCVS controller 130 may be partitioned into a two or more smaller frequency ranges, in which the frequency range supported by the DCVS controller 130 may span the minimum and maximum frequencies supported by the DCVS controller 130. In these aspects, a respective eater value may be assigned to each one of the smaller frequency ranges. Each frequency of the clock signal Clk in the look-up table may then be mapped to one of the assigned eater values according to which one of the smaller frequency ranges the frequency lies.

For example, the frequency range supported by the DCVS controller 130 may be partitioned into first, second and third frequency ranges, in which the first frequency range is lower than the second and third frequency ranges, and the second frequency range is lower than the third frequency range. In this example, an eater value of N1 is assigned to the first frequency range, an eater value of N2 is assigned to the second frequency range, and an eater value of N3 is assigned to the third frequency range, in which N3 is greater than N2, and N2 is greater than N1. In this example, each frequency of the clock signal Clk in the look-up table lying within the first frequency range is mapped to the eater value of N1, each frequency of the clock signal Clk in the look-up table lying within the second frequency range is mapped to the eater value of N2, and each frequency of the clock signal Clk in the look-up table lying within the third frequency range is mapped to the eater value of N3.

An advantage of using the eater value controller 450 to program the clock eater value of the clock eater 420 is that it may eliminate the need for software running on one of the processors (e.g., CPU) to program the clock eater value of the clock eater 420, thereby reducing the power of the processor.

In certain aspects, the eater value controller 450 may be omitted. For example, the clock eater value of the clock eater 420 may be fixed or programmed by one of the processors 110-1 to 110-4, in which case, the eater value controller 450 may be omitted.

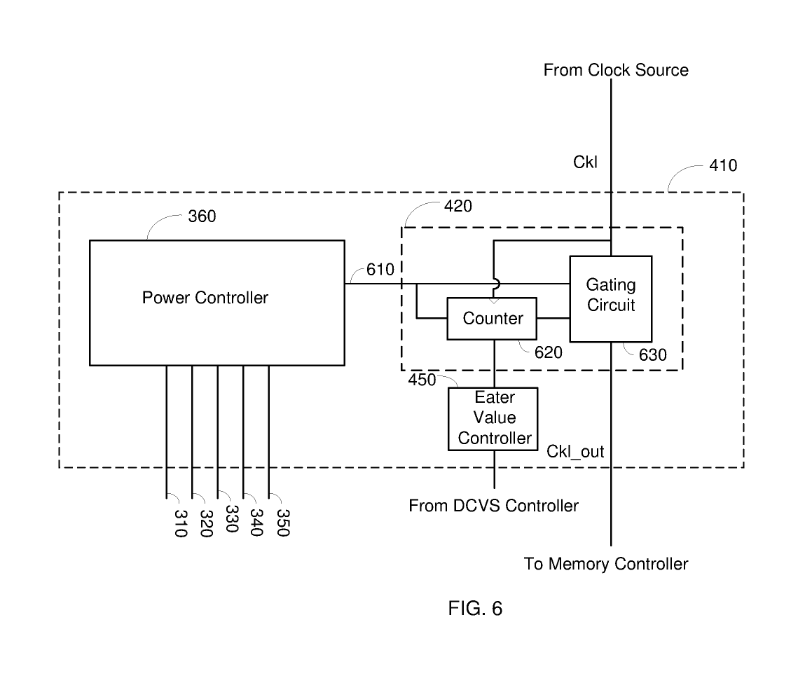

FIG. 6 shows an exemplary implementation of the clock eater 420 according to certain aspects of the present disclosure. In this example, the clock eater 420 includes a counter 620, and a gating circuit 630. The counter 620 may be driven by the clock signal Clk, as shown in FIG. 6.

In operation, the clock eater 420 receive a control signal 610 from the power controller 360, in which the control signal 610 indicates whether the clock eater 420 is to operate in the first mode or the second mode. When the control signal 610 indicates that the clock eater is to operate in the first mode, the counter 620 counts the number of cycles of the clock signal Clk and sends a pass signal to the gating circuit 630 every Nth clock cycle. The gating circuit 630 passes one clock pulse of the clock signal Clk each time the gating circuit 630 receives a pass signal from the counter 620, and eats (swallows) the other clock pulses of the clock signal Clk. Since the counter 620 outputs a pass signal every Nth cycle of the clock signal Clk, the counter 620 causes the gating circuit 630 to pass every Nth clock pulse of the clock signal Clk. Thus, when the memory controller 120 is in the idle state, the frequency of the clock signal output to the memory controller 110 (denoted “Clk_out”) is controlled by the clock eater value N.

For example, if the clock eater value N is equal to four, then the counter 620 sends a pass signal to the gating circuit 630 every fourth clock cycle. This causes the gating circuit 630 to pass every fourth clock pulse of the clock signal Clk, thereby reducing the clock frequency by 75% (equivalent to dividing the clock frequency by four). This example is illustrated in FIG. 5 discussed above. Thus, the amount by which the clock eater 420 reduces the frequency of the clock signal Clk can be programmed by programming the clock eater value N. As discussed above, the clock eater value N may be programmed by the eater value controller 450 (e.g., based on the frequency of the input clock signal Clk).

When the control signal 610 indicates that the clock eater 420 is to operate in the second mode, the gating circuit 630 allows the clock signal Clk to pass to the memory controller 120 without clock eating (swallowing). In this case, the counter 620 may be disabled to conserve power.

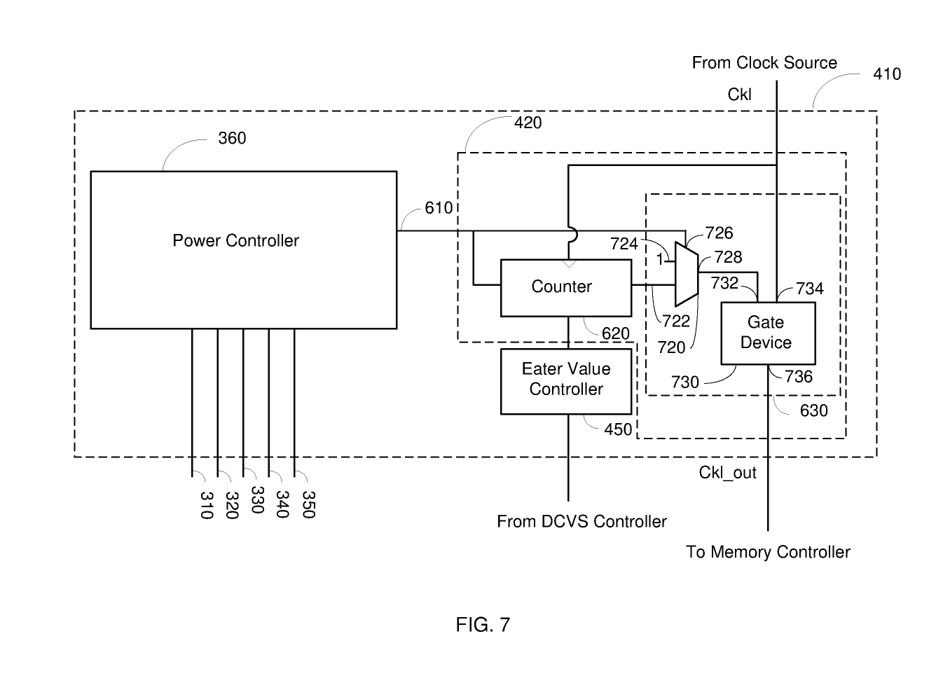

FIG. 7 shows an exemplary implementation of the gating circuit 630 according to certain aspects of the present disclosure. In this example, the gating circuit 630 includes a multiplexer 720, and a gate device 730. The multiplexer 720 has a first input 724 that is held at logic one (denoted “1” in FIG. 7), a second input 720 coupled to the output of the counter 620, and a select input 726 coupled to the control signal 610 from the power controller 360. The multiplexer 720 selects the first input 724 when the control signal 610 indicates that the clock eater 420 is to operate in the second mode, and selects the second input 722 when the control signal 610 indicates that the clock eater 420 is to operate in the first mode. Thus, the multiplexer 720 outputs a logic one in the second mode, and outputs the output of the counter 620 in the first mode.

The gate device 730 has a first input 732 coupled to the output 728 of the multiplexer 720, a second input 734 coupled to the clock signal Clk, and an output 736 that provides the output clock signal Clk_out to the memory controller 120. In this example, the gate device 730 may perform a logical AND function, in which the gate device 730 outputs a logic one when both the first and second inputs 732 and 734 are at logic one, and outputs a logic zero when at least one of the first and second inputs 732 and 734 is at logic zero.

When the control signal 610 indicates that the clock eater 420 is to operate in the first mode, the counter 620 is enabled and the multiplexer 720 selects the second input 722. As a result, the output of the counter 620 is coupled to the first input 732 of the gate device 730. The counter 620 counts the number of cycles of the clock signal Clk and sends a pass signal to the first input 732 of the gate device 730 every Nth clock cycle, in which the pass signal has a logic value of one and a duration of approximately one cycle of the clock signal Clk. The counter 620 outputs a logic zero for the remaining clock cycles. Since the gate device 730 performs a logical AND function in this example, this causes the gate device 730 to pass one out of every Nth clock pulse of the clock signal Clk to the output 736, and block (eat) the other clock pulses of the clock signal Clk.

When the control signal 610 indicates that the clock eater 420 is to operate in the second mode, the counter 620 is disabled and the multiplexer 720 selects the first input 724. As a result, the multiplexer 720 outputs a logic one to the first input 732 of the gate device 730. Since the gate device 730 performs a logical AND function in this example, this causes the gate device 730 to pass the clock signal Clk to the memory controller 120.

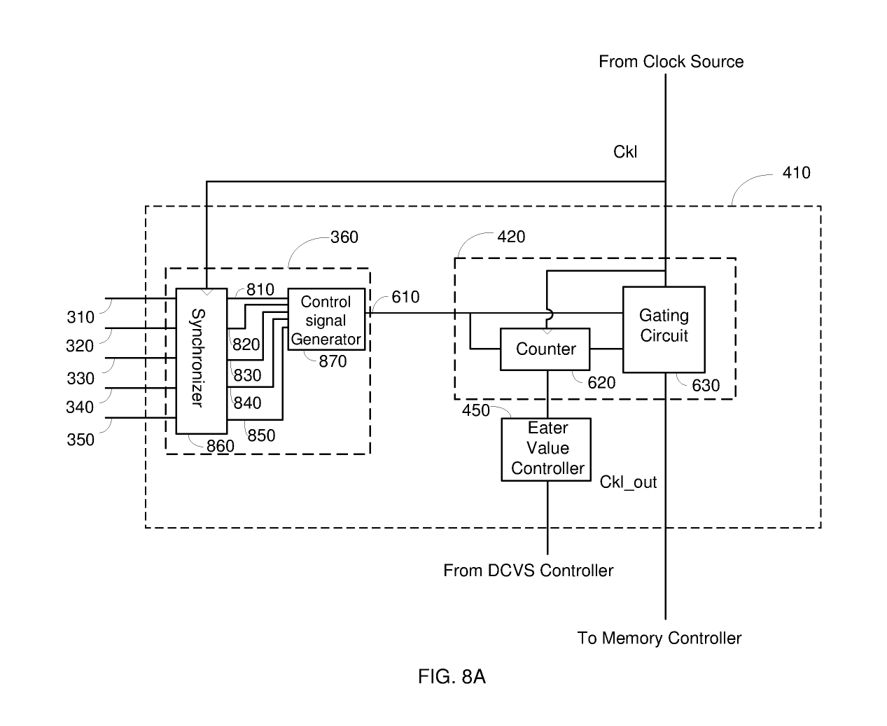

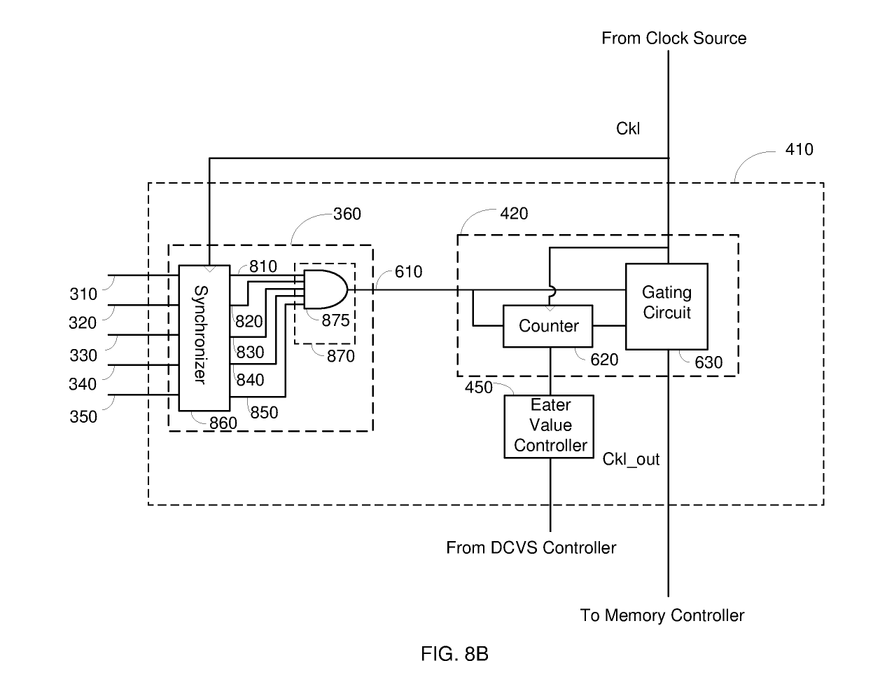

FIG. 8A shows an exemplary implementation of the power controller 360 according to certain aspects of the present disclosure. In this example, the power controller 360 includes a synchronizer 860 and a control signal generator 870.

The synchronizer 860 is configured to receive the clock signal Clk and the state signals 310, 320, 330, 340 and 350 from the clock switch engine 270, the arbiter 215, the memory organizer 220, the memory protocol engine 230 and/or the housekeeping engine 250. The synchronizer 860 synchronizes the received state signals 310, 320, 330, 340 and 350 with the clock signal Clk to produce synchronized state signals 810, 820, 830, 840 and 850, respectively. For example, the synchronizer 860 may synchronize edges of the state signals 310, 320, 330, 340 and 350 with one or more edges of the clock signal Clk.

The synchronizer 860 allows the power controller 360 to receive one or more state signals that are asynchronous with the clock signal Clk, and synchronize the one or more state signals with the clock signal Clk. For example, as discussed above, the housekeeping engine 250 may time housekeeping operations according to the clock signal from the housekeeping clock source 260, which may be asynchronous with the clock signal Clk. As a result, the state signal 350 from the housekeeping engine 250 may be asynchronous with the clock signal Clk.

The synchronized state signals 810, 820, 830, 840 and 850 are input to the control signal generator 870. The control signal generator 870 is configured to generate the control signal 610 based on the synchronized state signals 810, 820, 830, 840 and 850. For example, the control signal generator 870 may cause the control signal 610 to indicate that the clock eater 420 is to operate in the first mode when all of the synchronized state signals 810, 820, 830, 840 and 850 indicate that the respective sub-blocks are idle. The control signal generator 870 may cause the control signal 610 to indicate that the clock eater 420 is to operate in the second mode when at least one of the synchronized state signals 810, 820, 830, 840 and 850 indicates that the respective sub-block is active.

In one example, the control signal generator 870 may include an AND gate 875, as shown in FIG. 8B. In this example, the synchronized state signals are input to the AND gate 875, and the control signal 610 is taken at the output of the AND gate 875. The AND gate 875 is configured to perform a logical AND function on the synchronized state signals 810, 820, 830, 840 and 850 to produce the control signal 610 of the power controller 360. In this example, each state signal 310, 320, 330, 340 and 350 has a logic value of one when the respective sub-block is idle, and a logic value of zero when the respective sub-block is active. Also, the control signal 610 has a logic value of one when the clock eater 420 is to operate in the first mode, and a logic value of zero when the clock eater 420 is to operate in the second mode.

In this example, the AND gate 875 causes the control signal 610 to be one (i.e., indicate that the clock eater 420 is to operate in the first mode) when all of the state signals 310, 320, 330, 340 and 350 are one (e.g., each of the clock switch engine 270, the arbiter 215, the memory organizer 220, the protocol engine 230, and the housekeeping engine 250 is idle). The AND gate 875 causes the control signal 610 to be zero (i.e., indicate that the clock eater 420 is to operate in the second mode) when at least one of the state signals 310, 320, 330, 340 and 350 is zero (e.g., at least one of the clock switch engine 270, the arbiter 215, the memory organizer 220, the protocol engine 230, and the housekeeping engine 250 is active). It is to be appreciated that the power controller 360 is not limited to the exemplary implementations shown in FIG. 8A and 8B, and may be implemented using other logic.

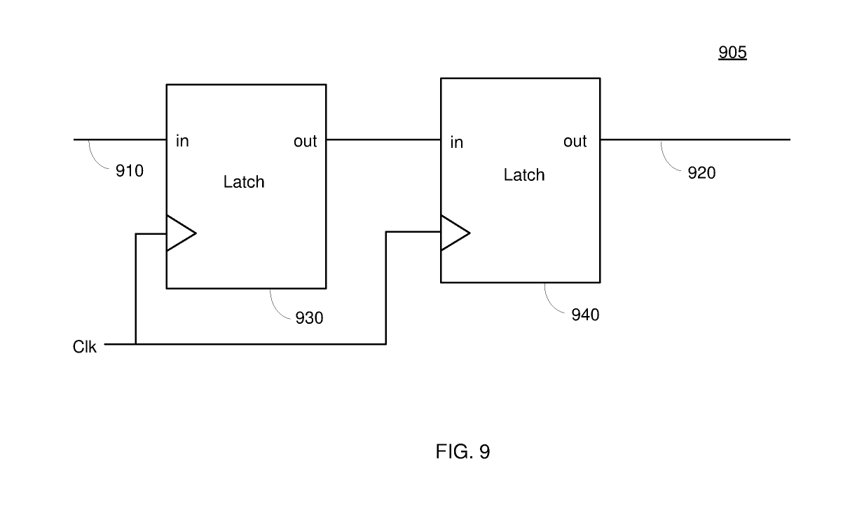

FIG. 9 shows an exemplary implementation of a portion 905 of the synchronizer 860 according to certain aspects of the present disclosure. In this example, the portion 905 of the synchronizer 860 shown FIG. 9 is configured to synchronize an input state signal 910 into a synchronized state signal 920, which may be input to the control signal generator 870. The input state signal 910 may be any one of the state signals 310, 320, 330, 340 and 350 shown in FIG. 8A or 8B, and the synchronized state signal 920 may be the respective synchronized state signal 810, 820, 830, 840 and 850 shown in FIG. 8A or 8B.

The portion 905 of the synchronizer 860 includes a first latch 930 and a second latch 940, in which each of the latches 930 and 940 is clocked by the clock signal Clk. The first latch 930 has an input (denoted “in”) that receives the state signal 910, and an output (denoted “out”) that is coupled to the input (denoted “in”) of the second latch 940. The output (denoted “out”) of the second latch 940 provides the synchronized state signal 920. Each of the latches 930 and 940 is configured to latch the logic value at the input of the latch on an edge of the clock signal Clk, and output the latched logic value at the output of the latch on the same edge or another edge of the clock signal Clk. Each of the latches may be implemented with a flip-flop, or another type of latch. Also each of the latches may be positive-edge (rising-edge) triggered, or negative-edge (falling-edge) triggered. Although two latches are shown in the example in FIG. 9, it is to be appreciated that the portion 905 of the synchronizer may include one latch, or more than two latches coupled in series.

The portion 905 of the synchronizer 860 shown in FIG. 9 may be duplicated for each one of the state signals 310, 320, 330, 340 and 350 shown in FIG. 8A or 8B to produce the respective synchronized state signal 810, 820, 830, 840 and 850.

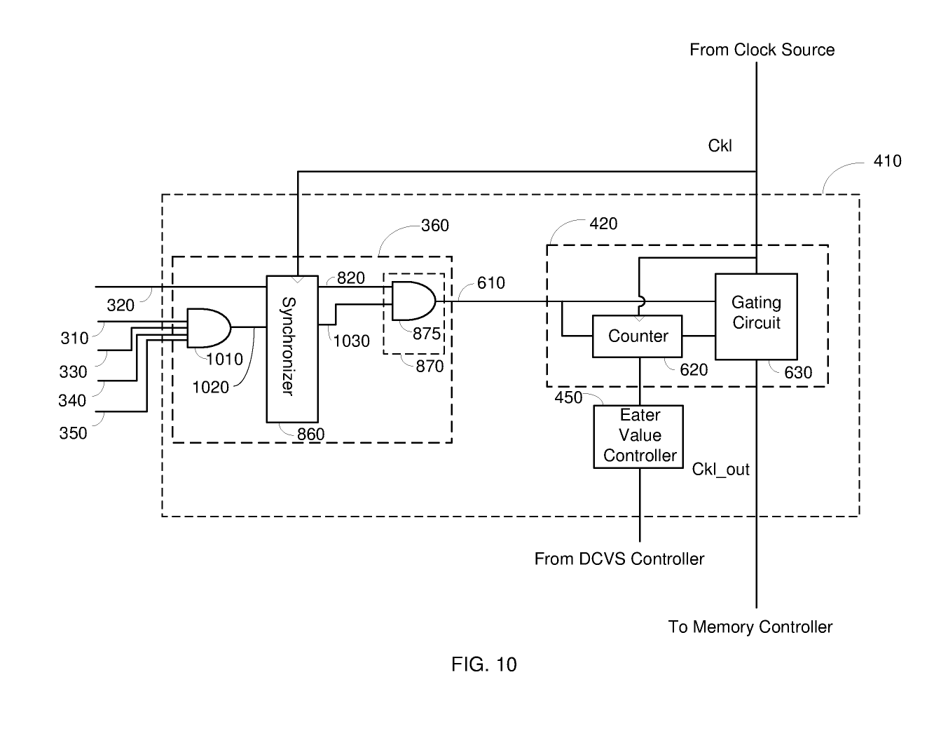

In certain aspects, two or more of the state signals 310, 320, 330, 340 and 350 may be aggregated before being input to the synchronizer 860. In this regard, FIG. 10 shows an example in which the state signals 310, 330, 340 and 350 from the clock switch engine 270, the memory organizer 220, the protocol engine 230 and the housekeeping engine 250 are aggregated by an AND gate 1010 to produce aggregated signal 1020. The aggregated signal 1020 is input to the synchronizer 860, which synchronizes the aggregated signal 1020 with the clock signal Clk to produce synchronized signal 1030. The synchronized signal 1030 is then input to the AND gate 875, as shown in FIG. 10. In the example shown in FIG. 10, the state signal 320 from the arbiter 215 is synchronized by the synchronizer 860, and the resulting synchronized signal 820 is also input the AND gate 875, same as in FIG. 8B.

In this example, each state signal 310, 330, 340 and 350 may have a logic value of one when the respective sub-block is idle, and a logic value of zero when the respective sub-block is active. Thus, the aggregated state signal 1020 is logic one when all of the state signals 310, 330, 340 and 350 input to the AND gate 1010 are logic one, and is logic zero when at least one of the state signals 310, 330, 340 and 350 input to the AND gate 1010 is logic zero. It is to be appreciated that the present disclosure is not limited to the exemplary implementation shown in FIG. 10, and that the state signals 310, 320, 330, 340 and 350 may be aggregated in different combinations.

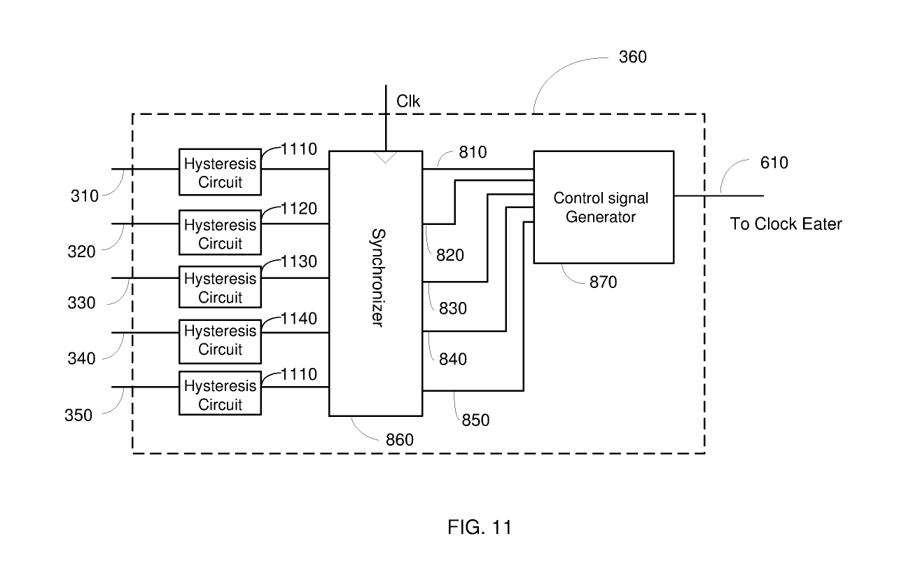

FIG. 11 shows the power controller 360 according to certain aspects of the present disclosure. For ease of illustration, the clock eater 420 and eater value controller 450 are not shown in FIG. 11. In this example in FIG. 11, the power controller 360 includes multiple hysteresis circuits 1110, 1120, 1130, 1140 and 1150, in which each of the hysteresis circuits corresponds to a respective one of the state signals 310, 320, 330, 340 and 350. Each hysteresis circuit receives the respective state signal, as discussed further below.

Operations of each hysteresis circuit will now be described according to certain aspects. When the state signal input to the hysteresis circuit transitions from active state to idle state, the state signal output by the hysteresis circuit (e.g., to the synchronizer 860) does not immediately transition to the idle state. Instead, the state signal output by the hysteresis circuit transitions to the idle state if the state signal input to the hysteresis circuit remains idle for a predetermined time duration. If the state signal input to the hysteresis circuit is idle for a time duration that is shorter than the predetermination time duration, then the state signal output by the hysteresis circuit does not transition to the idle state (i.e., stays in the active state). Thus, the state signal output by the hysteresis circuit does not go idle until the state signal input to the hysteresis circuit remains idle for the predetermined time duration. This is done to avoid triggering the clock eater 420 when the respective sub-block is only idle for a short period of time (e.g., due to a short delay in a request).

When the state signal input to the hysteresis circuit transitions from idle state to active state, the state signal output by the hysteresis circuit (e.g., to the synchronizer 860) may quickly transition from idle state to active state. This may be done to quickly transition the memory controller 120 from idle state to active state (e.g., to quickly service a read/write request). In other words, this may be done to minimize the wakeup latency of the memory controller 120. Thus, the hysteresis circuit may apply the predetermined time duration when the state signal input to the hysteresis circuit transitions from active state to idle state, but not when the state signal input to the hysteresis circuit transitions from idle state to active state.

It is to be appreciated that the predetermined time durations for the hysteresis circuits may be the same or different. It is also to be appreciated that one or more of the hysteresis circuits may be positioned after the synchronizer 860 rather than before the synchronizer 860, as shown in the example in FIG. 11. It is also to be appreciated that two or more state signals may share a hysteresis circuit. For example, the two or more state signals may be aggregated (e.g., using an AND gate), and the resulting aggregated state signal may be input to the hysteresis circuit. For instance, a hysteresis circuit may be coupled between the AND gate 1010 and the synchronizer 860 shown in FIG. 10. Therefore, it is to be appreciated that the present disclosure is not limited to the example shown in FIG. 11.

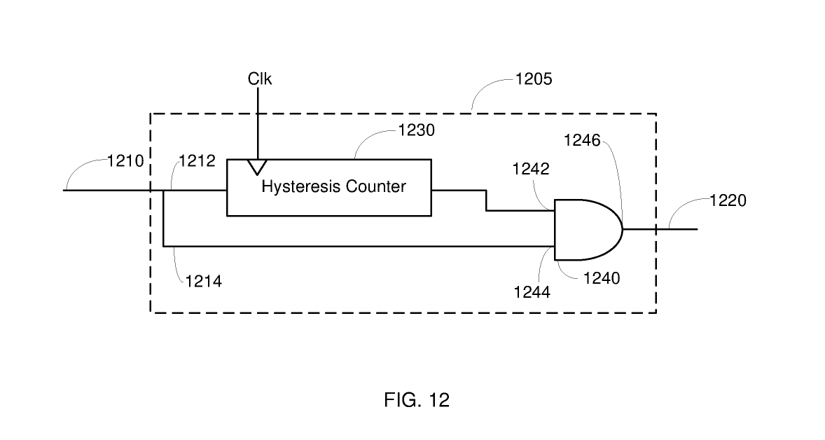

FIG. 12 shows an exemplary implementation of a hysteresis circuit 1205 according to certain aspects. The hysteresis circuit 1205 may be used to implement each of the hysteresis circuits 1110, 1120, 1130, 1140 and 1150 shown in FIG. 11. The hysteresis circuit 1205 includes a hysteresis counter 1230, and an AND gate 1240. The state signal input to the hysteresis circuit 1205 may be split among a first signal path 1212 and a second signal path 1214, in which the first signal path 1212 is coupled to an input of the hysteresis counter 1230. The AND gate 1240 has a first input 1242 coupled to an output of the hysteresis counter 1230, a second input 1244 coupled to the second path 1214, and an output 1246 that provides the state signal 1220 output by the hysteresis circuit 1205. In this example, the input state signal 1210 has a logic value of one when the respective sub-block is idle, and a logic value of zero when the respective sub-block is active.

The hysteresis counter 1230 may be driven by the clock signal Clk or another clock signal. In one example, the hysteresis counter 1230 is configured to start counting a number of cycles of the clock signal Clk when the input state signal 1210 transitions from active state to idle state (zero to one in this example), and to output a logic one to the first input 1242 of the AND gate 1240 when the count value of the hysteresis counter 1230 reaches a predetermined count value M, where M is an integer. The hysteresis counter 1230 is also configured to output a logic zero before the count value reaches M, and to reset the count value if the input state signal 1210 transitions back to the active state before the count value reaches M. Thus, in this example, the hysteresis counter 1230 outputs a logic one to the first input 1242 of the AND gate 1240 when the input state signal 1210 remains in the idle state for a predetermined time duration set by the predetermined count value M.

In operation, when the input state signal 1210 transitions from active state to idle state (zero to one in this example), the AND gate 1240 does not output a logic one indicating idle state until the input state signal remains in the idle state for the predetermined time duration. This is because the hysteresis counter 1230 does not output a logic one to the AND gate 1240 until the input state signal remains in the idle state for the predetermined time duration, as discussed above.

When the input state signal 1210 transitions from idle state to active state (one to zero in this example), the AND gate 1240 may quickly transition from one to zero indicating active state. This is because the input state signal is directly coupled to the second input 1244 of the AND gate 1240 via the second signal path 1214. As a result, when the input state signal 1210 changes to logic zero, the AND gate 1240 immediately outputs logic zero regardless of the logic value of the hysteresis counter 1230. Thus, the hysteresis circuit 1205 applies the predetermined time duration when the input state signal transitions from active state to idle state, but not when the input state signal transitions from idle state to active state.

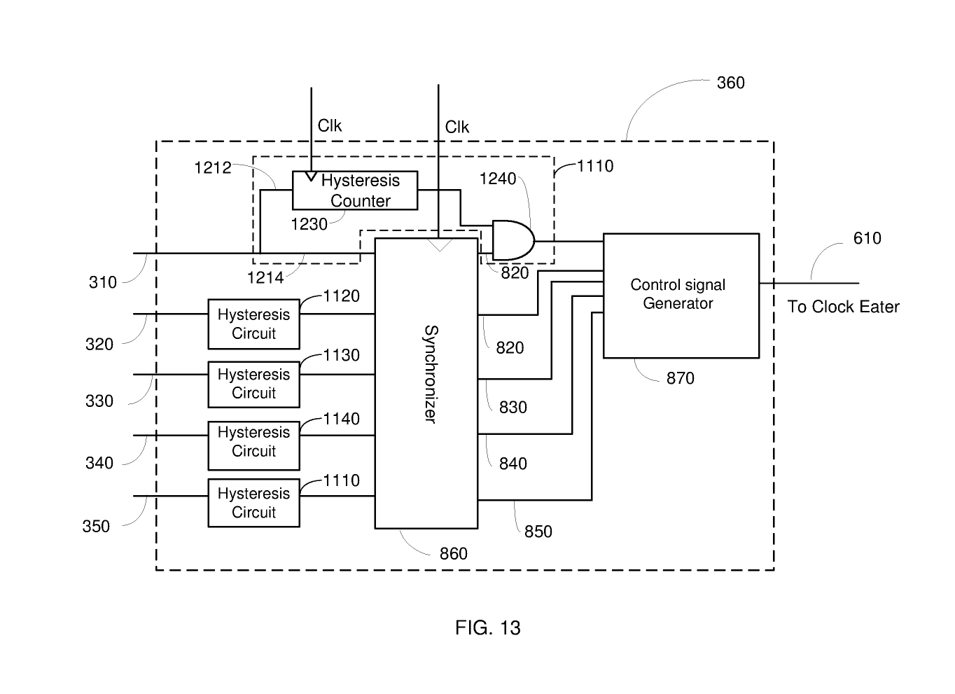

In certain aspects, the second path 1214 of the hysteresis circuit may pass through the synchronizer 860. In this regard, FIG. 13 shows an example in which the hysteresis circuit 1110 for the state signal 1320 from the arbiter 215 is implemented using the hysteresis circuit 1205 shown in FIG. 12. In this example, the second path 1214 of the hysteresis circuit 1110 passes through the synchronizer 860, as shown in FIG. 13. As a result, the synchronized state signal 820 is input to the second input of the AND gate 1240 of the hysteresis circuit 1110. In this example, the output of the hysteresis counter 1230 may already be synchronized with the clock signal Clk, and therefore may not need to be separately synchronized by the synchronizer 860. For instance, the hysteresis counter 1230 may be driven by the clock signal Clk, or another clock signal synchronized with the clock signal Clk.

In the above discussion, it is to be appreciated that a state signal in the idle state may refer to the state signal indicating that the respective sub-block is idle, and a state signal in the active state may refer to the state signal indicating that the respective sub-block is active.

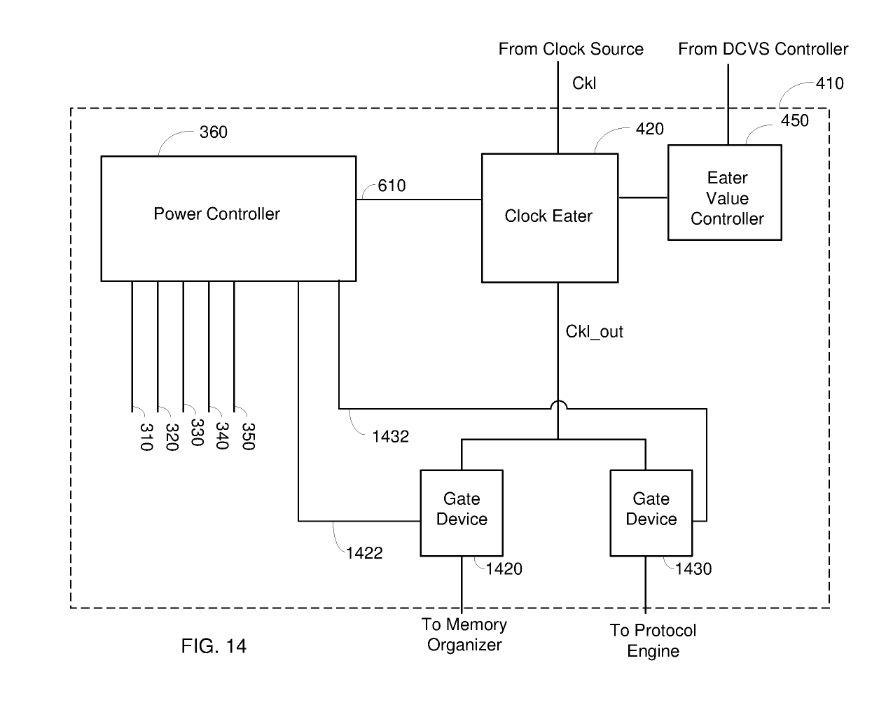

In certain aspects, the power management device 410 may also be capable of independently gating the clock signal to one or more of the sub-blocks of the memory controller 120. In this regard, FIG. 14 shows an example in which the power management device 410 includes a first gate device 1420 for selectively gating the clock signal to the memory organizer 220 (not shown in FIG. 14), and a second gate device 1430 for selectively gating the clock signal to the memory protocol engine 230 (not shown in FIG. 14). The first and second gate devices 1420 and 1430 are positioned after the clock eater 420 in the clock distribution tree shown in FIG. 14, and thus receive the clock signal Clk_out output by the clock eater 420. In this example, the power controller 360 controls the first gate device 1420 via first control signal 1422, and controls the second gate device 1430 via second control signal 1432. It is to be appreciated that the present disclosure is not limited to the exemplary clock gating architecture shown in FIG. 14.

In operation, the power controller 360 may gate the clock signal to the memory organizer 220 when the state signals 320 and 330 from the arbiter 215 and the memory organizer 220 are both idle. In this case, the clock signal to the memory organizer 220 is blocked. This reduces switching activity in the memory organizer 220, thereby reducing dynamic power of the memory organizer. The power controller 360 may un-gate the clock signal to the memory organizer 220 (i.e., allow the clock signal to pass to the memory organizer) when the state signal 320 and 330 from at least one of the arbiter 215 and the memory organizer 220 is active. For example, the power controller 360 may un-gate the clock signal to the memory organizer 220 when the state signal 320 from the arbiter 215 transitions from idle to active, which may indicate that a read/write requests has been received by the memory controller 120 and needs to be serviced by the memory organizer.

The power controller 360 may gate the clock signal to the protocol engine 230 when the state signals 330 and 340 from the memory organizer 220 and the protocol engine 230 are both idle. In this case, the clock signal to the protocol engine 230 is blocked. The power controller 360 may un-gate the clock signal to the protocol engine (i.e., allows the clock signal to pass to the protocol engine) when the state signal 330 and 340 from at least one the memory organizer 220 and the protocol engine 230 is active. For example, the power controller 360 may un-gate the clock signal to the protocol engine 230 when the state signal 330 from the memory organizer 220 transitions from idle to active, which may indicate that the memory organizer 220 needs the protocol engine 230 to perform a read/write operation to service a read/write request.

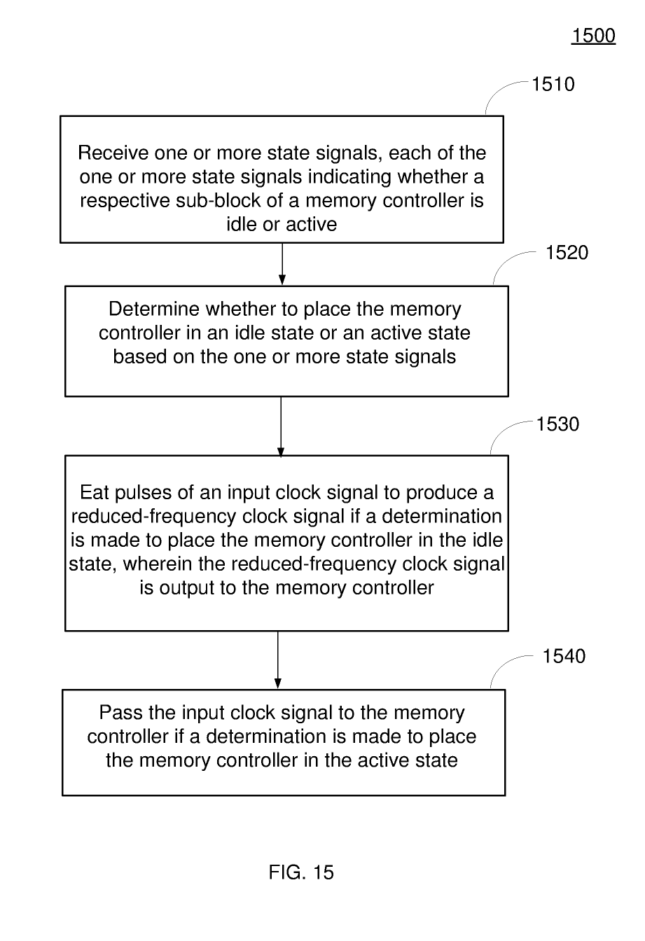

FIG. 15 is a flowchart illustrating a method 1500 for power management according to certain aspects of the present disclosure. The method 1500 may be performed by the power management device 410.

In step 1510, one or more state signals are received, each of the one or more state signals indicating whether a respective sub-block of a memory controller is idle or active. For example, the one or more state signals may include one or more of the state signals 310, 320, 330, 340 and 350 discussed above.

In step 1520, a determination is made whether to place the memory controller in an idle state or an active state based on the one or more state signals. For example, the one or more state signals may include multiple state signals. In this example, a determination may be made to place the memory controller in the idle state when each of the state signals indicates that the respective sub-block is idle, and a determination may be made to place the memory controller in the active state when at least one of the state signals indicates that the respective sub-block is active.

In step 1530, pulses of an input clock signal are eaten to produce a reduced-frequency clock signal if a determination is made to place the memory controller in the idle state, wherein the reduced-frequency clock signal is output to the memory controller. For example, the pulses may be eaten according to a clock eater value specifying a percentage of the pulses of the input clock signal (e.g., clock signal Clk) to be eaten to produce the reduced-frequency clock signal (e.g., clock signal Clk_out).

In step 1540, the input clock signal is passed to the memory controller if a determination is made to place the memory controller in the active state.

It is to be appreciated that aspects of the present disclosure are not limited to the exemplary terminology used above. For example, it is to be appreciated that DCVS may also be referred to as dynamic voltage and frequency scaling (DVFS) or other terminology. Also, the idle state may also be referred to as a low-power state, a standby state, a sleep state or other terminology.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A power management device, comprising:
a power controller configured to receive one or more state signals, each of the one or more state signals indicating whether a respective sub-block of a memory controller is idle or active; and
a clock eater configured to operate in a first mode and a second mode, wherein, in the first mode, the clock eater is configured to eat pulses of an input clock signal to produce a reduced-frequency clock signal and to output the reduced-frequency clock signal to the memory controller, and, in the second mode, the clock eater is configured to pass the input clock signal to the memory controller;
wherein the power controller is further configured to make a determination to operate the clock eater in the first mode or the second mode based on the one or more state signals, and to command the clock eater to operate in the first mode or the second mode based on the determination.

2. The power management device of claim 1, wherein the one or more state signals comprise two or more state signals, and the power controller is configured to command the clock eater to operate in the second mode if at least one of the two or more state signals indicates that the respective sub-block is active.

3. The power management device of claim 2, wherein the power controller is configured to command the clock eater to operate in the first mode if each one of the two or more state signals indicates that the respective sub-block is idle.

4. The power management device of claim 1, wherein the power controller comprises a synchronizer configured to synchronize the one or more state signals with the input clock signal.

5. The power management device of claim 4, wherein the synchronizer comprises one or more latches, wherein each of the one or more latches is clocked by the input clock signal.

6. The power management device of claim 1, wherein the power controller comprises a hysteresis circuit configured to receive at least one of the one or more state signals and to produce an output state signal, the output state signal indicates idle if the at least one of the one or more state signals indicates idle for a predetermined time duration, and the output state signal indicates active if the at least one of the one or more state signal indicates idle for a time duration that is shorter than the predetermined time duration.

7. The power management device of claim 6, wherein the hysteresis circuit comprises a counter driven by the input clock signal, and the predetermined time duration is specified by a predetermined number of counts of the counter.

8. The power management device of claim 1, wherein, in the first mode, the clock eater is configured to eat the pulses of the input clock signal according to an eater value, the eater value specifying a percentage of pulses of the input clock signal that are eaten, and the power management device further comprises:
an eater value controller configured to set the eater value of the clock eater based on a frequency of the input clock signal.

9. The power management device of claim 8, wherein the eater value controller includes a look-up table that maps different available frequencies of the input clock signal to respective clock eater values, and the eater value controller is configured to determine the eater value of the clock eater according to the eater value in the look-up table that is mapped to the frequency of the input clock signal.

10. The power management device of claim 1, wherein the clock eater comprises:
a counter configured to count a number of cycles of the input clock signal; and
a gating circuit;
wherein, in the first mode, the counter is configured to output a pass signal to the gating circuit for one out of every N cycles of the input clock signal, N is an integer greater than one, the gating circuit is configured to pass one pulse of the input clock signal each time the counter outputs a pass signal.

11. A method for power management, comprising:
receiving one or more state signals, each of the one or more state signals indicating whether a respective sub-block of a memory controller is idle or active;
determining whether to place the memory controller in an idle state or an active state based on the one or more state signals;
eating pulses of an input clock signal to produce a reduced-frequency clock signal if a determination is made to place the memory controller in the idle state, wherein the reduced-frequency clock signal is output to the memory controller; and
passing the input clock signal to the memory controller if a determination is made to place the memory controller in the active state.

12. The method of claim 11, wherein the one or more state signals comprise two or more state signals, and determining whether to place the memory controller in the idle state or the active state comprises determining to place the memory controller in the active state if at least one of the two or more state signals indicates that the respective sub-block is active.

13. The method of claim 12, wherein determining whether to place the memory controller in the idle state or the active state comprises determining to place the memory controller in the idle state if each one of the two or more state signals indicates that the respective sub-block is idle.

14. The method of claim 11, further comprising synchronizing the one or more state signals with the input clock signal.

15. The method of claim 11, wherein eating the pulses of the input clock signal comprises eating the pulses of the input clock signal according to an eater value, the eater value specifying a percentage of pulses of the input clock signal that are eaten, and the method further comprises setting the eater value based on a frequency of the input clock signal.

16. An apparatus for power management, comprising:
means for receiving one or more state signals, each of the one or more state signals indicating whether a respective sub-block of a memory controller is idle or active; and
means for determining whether to place the memory controller in an idle state or an active state based on the one or more state signals;
means for eating pulses of an input clock signal to produce a reduced-frequency clock signal if a determination is made to place the memory controller in the idle state;
means for outputting the reduced-frequency clock signal to the memory controller; and
means for passing the input clock signal to the memory controller if a determination is made to place the memory controller in the active state.

17. The apparatus of claim 16, wherein the one or more state signals comprise two or more state signals, and the means for determining whether to place the memory controller in the idle state or the active state comprises means for determining to place the memory controller in the active state if at least one of the two or more state signals indicates that the respective sub-block is active.

18. The apparatus of claim 17, wherein the means for determining whether to place the memory controller in the idle state or the active state comprises means for determining to place the memory controller in the idle state if each one of the two or more state signals indicates that the respective sub-block is idle.

19. The apparatus of claim 16, further comprising means for synchronizing the one or more state signals with the input clock signal.

20. The apparatus of claim 16, wherein the means eating the pulses of the input clock signal comprises means for eating the pulses of the input clock signal according to an eater value, the eater value specifying a percentage of pulses of the input clock signal that are eaten, and the apparatus further comprises means for setting the eater value based on a frequency of the input clock signal.
